(19) United States
(12) Patent Application Publication
(10) Pub. No.: US 2004/0217600 A1
(43) Pub. Date: Nov. 4, 2004

(54) Latch assembly for sliding door

(76) Inventor: Kevin Argo, Sunland, CA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/789,380

(22) Filed: Feb. 27, 2004

Related U.S. Application Data
(60) Provisional application No. 60/451,047, filed on Feb. 28, 2003.

(51) Int. Cl. E05C 1/06

(52) U.S. Cl. 292/241

(57) ABSTRACT

A latch assembly providing continuous engagement with a corresponding door includes a housing, an actuator, a biasing member, a latch, and a cam. The housing may optionally include a handle. The actuator may include an actuator shaft and the actuator shaft may be optionally rotated by a handle, a thumbturn, a pushbutton, or a locking mechanism. The biasing member may be a spring, which may be positioned between the housing and the latch and which may consistently exert a force against the latch to bias the latch toward the locked position. The cam may be rotated by the actuator shaft and may contact a bottom surface of the latch. The cam may contact the latch at points of minimum and maximum thickness. When the cam contacts the latch at the point of minimum thickness, the latch is in the locked position and the biasing member biases the latch their in. When the cam is rotated from the locked position, the latch is pivoted to the unlocked position.

### CROSS-REFERENCES TO RELATED APPLICATIONS

This application claims priority under 35 U.S.C. § 119(e) to, and hereby incorporates by reference, U.S. Provisional Application No. 60/451,047, filed 28 Feb. 2003.

### FIELD OF THE INVENTION

This invention relates to latch mechanisms and, in particular, to latch mechanisms for sliding doors.

### BACKGROUND OF THE INVENTION

In a typical sliding door installation, such as often found in the case of patio doors, the door is latched by a mechanism mounted in the locked face of the stile of the sliding door. The mechanism often has a single hook, or other latching component, coacting with a receiving (keeper) component disposed in the door jamb. The latching component and the receiving component form a single-point latching mechanism to latch the door and maintain the door in a latched state. These single-point latching mechanisms are often satisfactory. However due to increasing concern about forced entry, there is an increasing need and demand for more securing latching mechanisms for sliding doors. In response to the concern about forced entry, multi-point latches have been developed. These mechanisms often employ multiple latching elements engaging making structures mounted on door jambs. These multi-point latches increase the security of the latch mechanisms, thereby diminishing the likelihood of forced entry. However, these mechanisms tend to be complicated and expensive. Moreover, these mechanisms often require substantial modification of the sliding door style before the latch and associated components can be installed. Thus, these mechanisms tend to be more difficult and hence, expensive, to install.

There is thus a need for a latch assembly which is simple to operate, inexpensive to purchase, and easily adapted to most door arrangements. There is a further need for a latch assembly designed to provide increased security against forced entry, especially by preventing the latch from being forced or pried from the a locked position.

### SUMMARY OF THE INVENTION

This invention substantially meets the aforementioned needs of the industry by providing a latch assembly, which is simple to operate, inexpensive to purchase and easily adapted to most door arrangements. The locking device of this invention is designed to provide increased security against forced entry, especially by preventing the latch from being forced or pried from the locked position.

The lock assembly of this invention is adapted to be installed on a door, e.g., a sliding door, so that the present lock assembly can engage a door jamb when in a locked position. The latch assembly of this invention is self-contained, but may be fitted with a variety of optional components, such as door handles, exterior pulls, and locks. Moreover, the latch assembly of this invention can be simply and inexpensively integrated into a single assembled unit incorporating one or more of the foregoing additional components.

It is therefore an object of this invention, to provide a latch assembly, which may include a housing, a latch, and a cam. The housing assembly may be operably disposable on a plane. The latch may extend from the housing and may pivot generally perpendicularly to the plane on which the housing is disposable. The latch may further pivot between a locked position and an unlocked position and may be biased toward the locked position. The cam may pivot the latch between the locked position and the unlocked position by contacting the latch as rotated. A pin may be affixed to the housing so as to provide a rotational axis for the latch. The latch per se may be capable of engaging a corresponding door jamb without the need for a separate keeper element; however, a separate keeper element may be used as well.

A further object of this invention is to provide a method of operating a latch assembly mounted on a door. The latch assembly may include a housing operably disposable on a plane, a latch, and a cam. The latch may extend from the housing, may pivot generally perpendicular to the plane between a locked position and an unlocked position, and may be biased toward the locked position. The method may include closing the door and rotating the cam, thereby pivoting the latch from the unlocked position to the locked position, the latch contacting a door jamb when in the locked position, and the latch being biased in the locked position.

A still further object of this invention is to provide a method of manufacturing a latch assembly. The method may include providing a housing disposable on a generally planar surface; rotationally disposing a cam and an actuator shaft in the housing such that the cam is attached to the actuator shaft; extending a latch from the housing in a contacting relation to the cam so that the latch pivots generally perpendicularly to the planar surface between a locked position and an unlocked position; and positioning a biasing member so as to bias the latch toward the locked position.

It is a feature of the instant latch assembly that the latch is biased toward the locked position.

It is an advantage of the foregoing feature that the latch is not easily positioned away from the locked position.

It is another advantage of the foregoing feature that forced entry is made more difficult.

It is another feature of the instant latch assembly that the cam includes points of minimum and maximum thicknesses.

It is an advantage of the foregoing feature that the latch is securely positioned in the unlocked position when the latch contacts the point of maximum thickness.

It is another advantage of the foregoing feature that the biasing member is allowed to exert a force on the latch to maintain the latch in the locked position.

These and other objects, features, and advantages of this invention will become apparent from the description which follows, when considered in view of the accompanying drawings.

### BRIEF DESCRIPTION OF THE DRAWINGS

FIG. 1 is an isometric view of one embodiment of the clam latch assembly of this invention;

FIG. 2 is a front view of the clam latch assembly of FIG. 1;

FIG. 3 is a top view of the clam latch assembly of FIG. 1;

FIG. 4 is a bottom view of the clam latch assembly of FIG. 1;

FIG. 5 is a side view of the clam latch assembly of FIG. 1;

FIG. 6 is a cross sectional view of the clam latch of this invention in an unlocked position;

FIG. 7 is a cross sectional view of the clam latch of this invention in a locked position;

FIG. 8 is an isometric view of another embodiment of the clam latch assembly of this invention; and

FIG. 9 is an isometric view of yet another embodiment of the clam latch assembly of this invention.

It is understood that the above-described figures are only illustrative of the present invention and are not contemplated to limit the scope thereof.

### DETAILED DESCRIPTION

Unless otherwise defined, all technical and scientific terms used herein have the same meaning as commonly understood by one of ordinary skill in the art to which this invention belongs. In case of conflict, the present specification, including definitions, will control. In addition, the materials, methods, and examples are illustrative only and not intended to be limiting. Although methods and materials similar or equivalent to those described herein can be used to practice the invention, suitable methods and materials are described below.

Any references to such relative terms as top and bottom, and the like, are intended for convenience of description and are not intended to limit the present invention or its components to any one positional or spatial orientation. All dimensions of the components in the attached figures may vary with a potential design and the intended use of an embodiment of the invention without departing from the scope of the invention.

Each of the additional features and methods disclosed herein may be utilized separately or in conjunction with other features and methods to provide improved latch assemblies and methods for making and using the same. Representative examples of the teachings of the present invention, which examples utilize many of these additional features and methods in conjunction, will now be described in detail with reference to the drawings. This detailed description is merely intended to teach a person of skill in the art further details for practicing preferred aspects of the present teachings and is not intended to limit the scope of the invention. Therefore, only combinations of features and methods disclosed in the following detailed description may not be necessary to practice the invention in the broadest sense, and are instead taught merely to particularly describe representative and preferred embodiments of the invention.

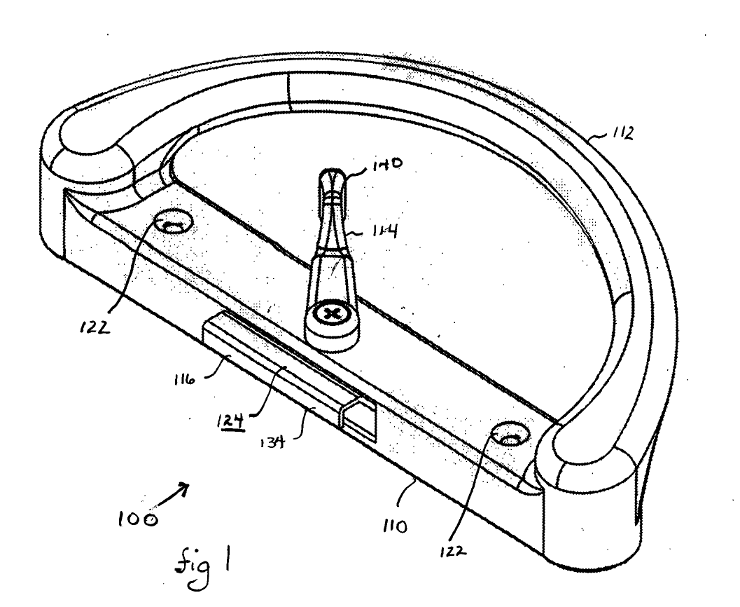

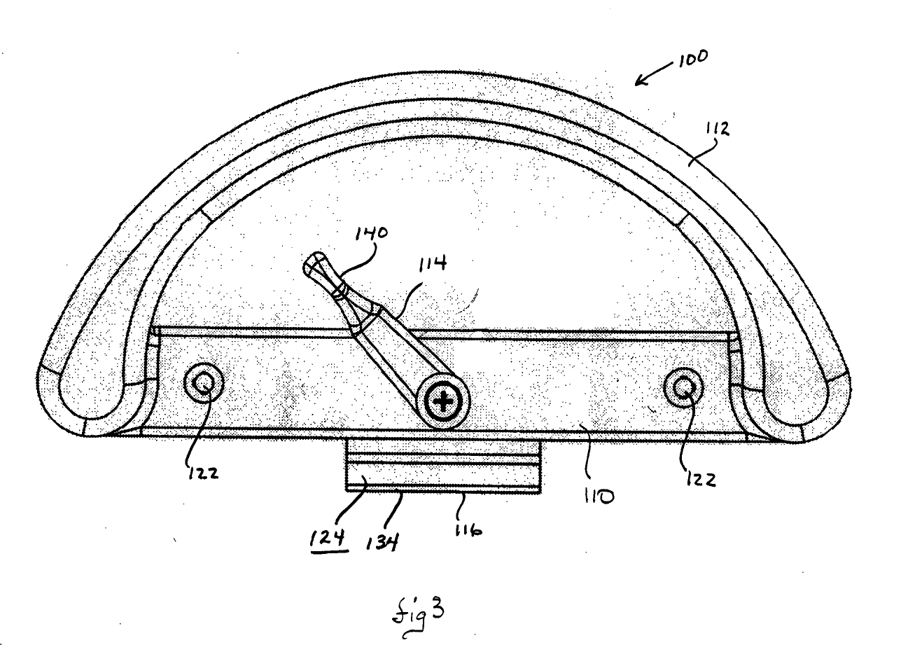

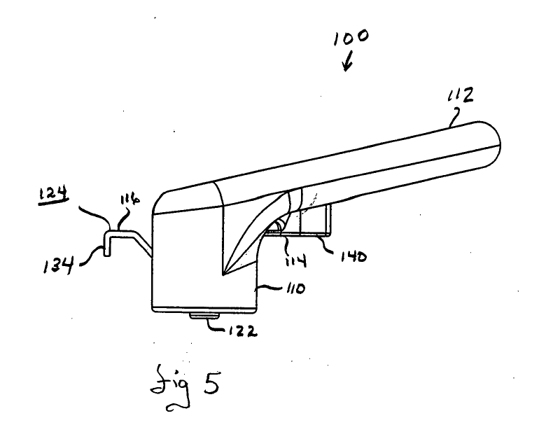

One embodiment of the present clam latch assembly is depicted in FIGS. 1-6 generally at 100 an broadly includes a housing 110, an optional handle 112, an actuator device 114, a latch 116, a biasing member such as a spring 118, and a cam 120.

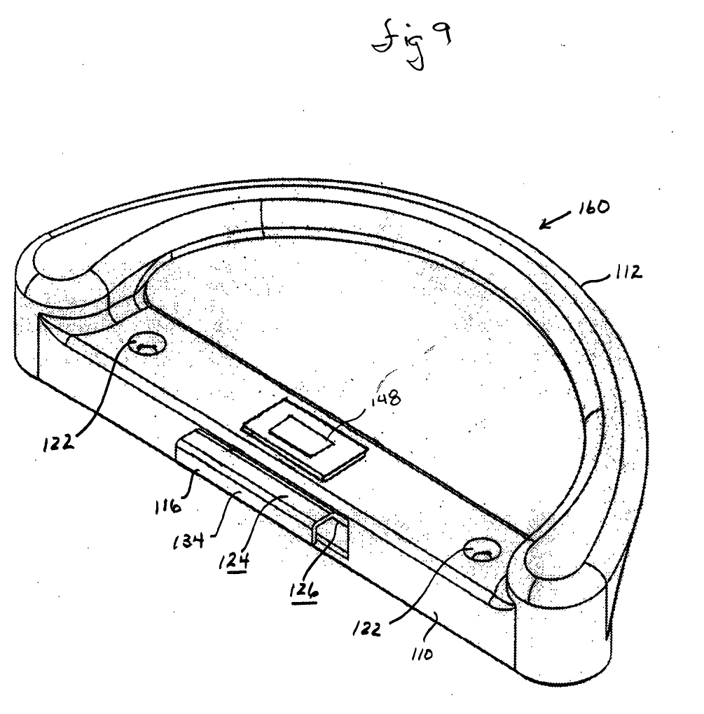

The housing 110 may be mountable to a sliding door (not shown) by way of fasteners (not shown) in mounting holes 122. Suitable fasteners for this purpose include screws, bolts, rivets, nails, adhesives, and the like. As an optional feature, the mounting holes 122 depicted allow fasteners to be countersunk for greater aesthetic appeal and safety. The handle 112 can either be unitary, or otherwise integral, with the housing 110 or can be separately attachable to the housing. As seen in FIG. 8, the handle may be absent in some embodiments of this invention. In FIG. 8, the latch assembly is shown at 150 to indicate a latch assembly similar, or substantially identical, to the latch assembly 100, except for the absence of the handle 112.

The actuator 114 may be positioned to be easily and readily accessible. In the embodiment depicted, the actuator 114 is a lever. However, the instant actuator can also be positioned as a thumbturn, a push button, or any other mechanical device capable of rotating the latch when desired.

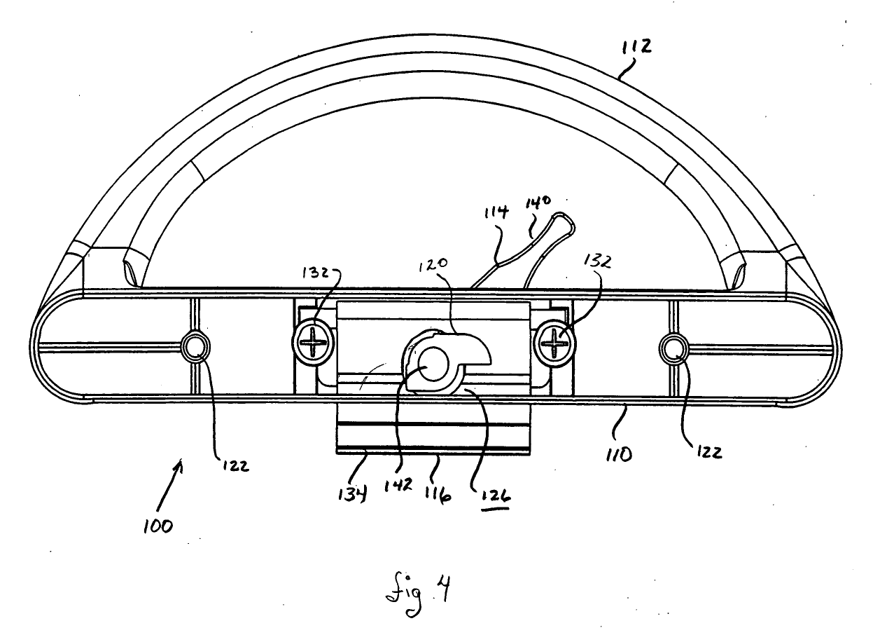

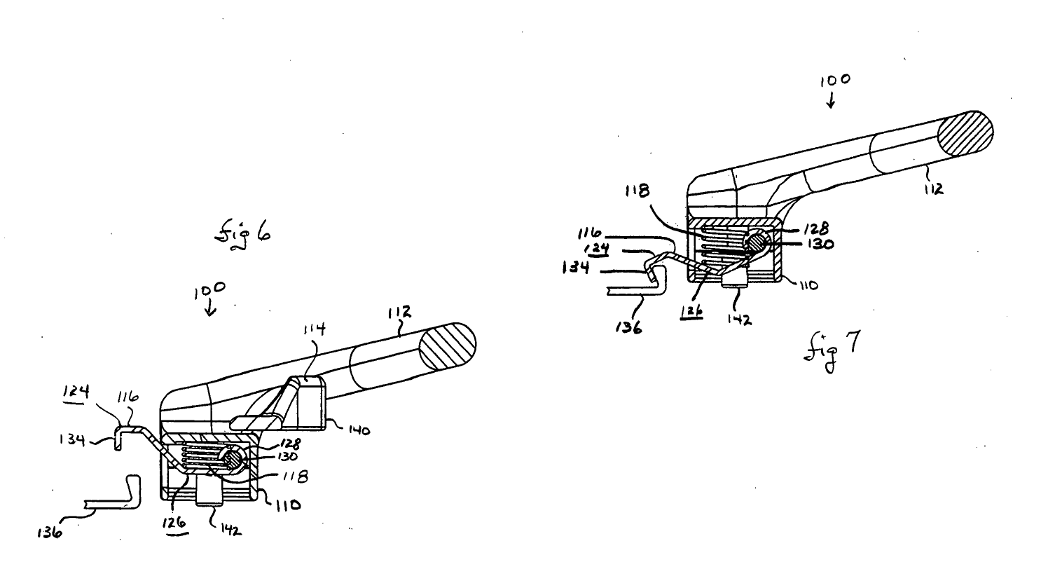

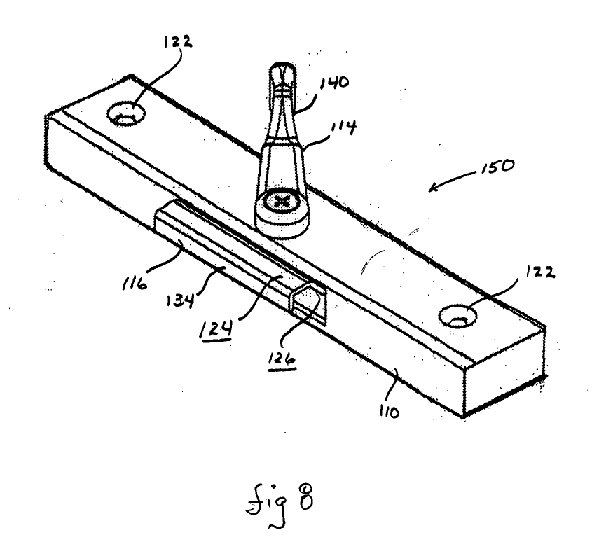

As best seen in FIGS. 4, 6, and 7, the latch 116 includes a top surface 124, a bottom surface 126, and a pin receiving portion 128. The latch 116 operably rotates about a pin 130 between an unlocked position (shown in FIG. 6) and a locked position (shown in FIG. 7), the pin 130 received within the pin receiving portion 128. The pin 130 is affixed to the housing 110 by at least one mechanical fastener, e.g., screws 132. The latch 116 is further shaped so as to define a catch portion 134. The catch portion 134 engages (to lock) and disengages (to unlock) a corresponding portion of a door jamb 136. Hence, depending upon the configuration of the door utilized, a separate keeper component may be eliminated.

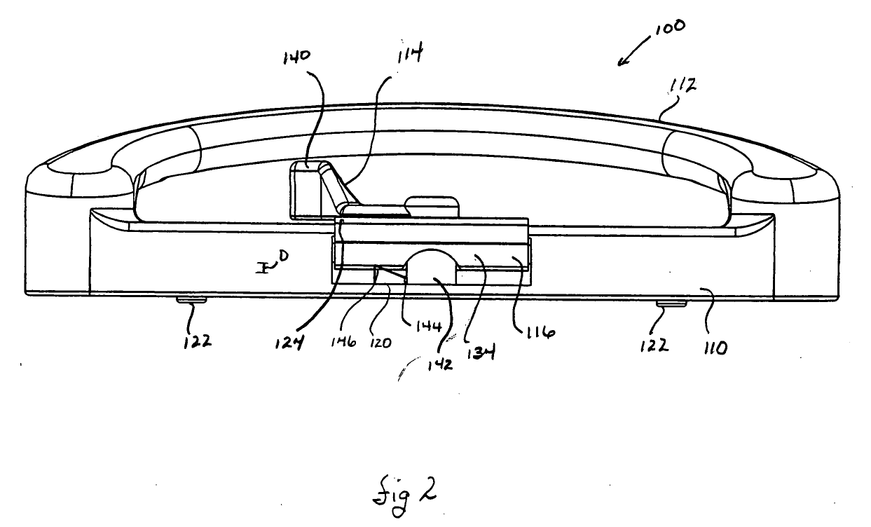

As best seen in FIG. 2, the present actuator 114 has a handle 140 attached to an actuator shaft 142. The swivel cam 120 is attached to the actuator shaft 142 so as to rotate when the actuator handle 140 is pivoted. Referring still to FIG. 2, the. swivel cam 120 is contoured at the point the swivel cam 120 contacts the latch 116. The contour of the cam 120 is at least partially defined by a point of minimum thickness indicated at 144 and a point of maximum thickness indicated at 146. The vertical distance between the point of minimum thickness 144 and the point of maximum thickness 146 is designated D. Functionally, the swivel cam 120 contacts the latch bottom surface 126 to position the latch 116 in either the locked or unlocked position. In the unlocked position shown in FIG. 6, the latch bottom surface 126 contacts the cam at the point of maximum thickness 146. In the locked position, the latch bottom surface 126 contacts the cam bottom surface 126 at the point of minimum thickness 146. The distance traveled between the latch catch portion 134 between the locked and unlocked positions is thus proportional to the distance D on the cam surface.

When the latch 116 is in the locked position, the spring 118 exerts a bias against the latch to provide a continuous engagement with the door jamb 136. The continuous engagement maintains the latch 116 in the locked position. In the embodiment depicted, the spring 118 is compressed between the lever and the latch top surface 124. The spring compression generates a force against the latch 116 toward the locked position.

In lieu of, or in addition to, the actuator 114, the latch assembly of this invention can include a lock assembly, which is shown in FIG. 9 at 148. The lock assembly 148 may be operated by a key lock mechanism (e.g., a keyed cylinder), a keyless mechanism (e.g., a combination mechanism), or any other mechanism capable of rotating the instant cam. The lock assembly 148 can also be present in addition to the actuator 114 to further secure the actuator in the locked and/or the unlocked position. The spring 118 is depicted as a typical coil spring. However, other biasing devices capable of exerting the required force against the latch 116 may be acceptable in other embodiments.

The present latch assembly may be mounted on a plane for use, e.g., a generally vertical plane defined by an inside surface of a door. When the clam latch assembly is mounted to a sliding door, the operator slides the door between an open position and a closed position by grasping the handle 112. In the unlocked position, the latch 116 is disengaged from the door jamb 136. In the unlocked position, the latch 116 contacts the point of can maximum thickness 146 and the spring 118 is compressed. Moving the actuator handle 140 from the unlocked position to the locked position rotates the actuator shaft 142, thereby rotating the cam 120 as well. When the cam 120 is rotated, the point of contact between the bold that latch bottom surface 126 is also rotated to the point of the minimum thickness 144 on the cam, thereby allowing the latch 116 to pivot generally perpendicularly to the plane on which the instant latch assembly is mounted. The latch 116 thereby pivots about the pin 130 and engages the door jamb 136 in the locked position. Simultaneously, the spring 118 is no longer held in the compressed position by the cam 120 and is allowed to exert a force against the latch 116. In the locked position, the latch 116 is held to a continuous engagement with the door jamb 136 by the force exerted on the latch by the spring 118. The force exerted on the latch 116 in the locked position helps prevent disengagement of the latch 116, thereby preventing forced entry. The latch assembly is returned to the unlocked position by pivoting the actuator handle 140, thereby rotating the cam to where the point of maximum thickness 146 contacts the latch bottom surface 126. At this point the latch 116 is forced away from the door jam 136 and compresses the spring 118.

Because numerous modifications of this invention may be made without departing from the spirit thereof, the scope of the invention is not to be limited to the embodiments illustrated and described. Rather, the scope of the invention is to be determined by the appended claims and their equivalents.

What is claimed is:

1. A latch assembly, comprising:
a housing operably disposable on a plane;
a latch extending from the housing, the latch pivoting generally perpendicularly to the plane between a locked position and an unlocked position and biased toward the locked position; and
a cam pivoting the latch between the locked position and the unlocked position.

2. The latch assembly of claim 1, further comprising an actuator shaft, the actuator shaft rotating the cam.

3. The latch assembly of claim 2, further comprising a handle, a thumbturn, or a pushbutton attachable to the actuator shaft.

4. The latch assembly of claim 2, further comprising a lock assembly in rotatable communication with the actuator shaft.

5. The latch assembly of claim 2, in which the cam rotates about a cam axis and the cam axis is generally parallel to the plane.

6. The latch assembly of claim 1, the cam comprising a cam surface generally sloping from a point of maximum thickness to a point of minimum thickness.

7. The latch assembly of claim 6, in which the latch contacts the point of minimum thickness when the latch is in the locked position and in which the latch contacts the point of maximum thickness when the latch is in the unlocked position.

8. The latch assembly of claim 1, further comprising a biasing member biasing the latch in the locked position.

9. The latch assembly of claim 8, in which the biasing member comprises a spring.

10. The latch assembly of claim 8, in which the biasing member is positioned between the housing and the latch.

11. The latch assembly of claim 1, further including a handle attached to the housing.

12. The latch assembly of claim 1, further comprising a pin and in which the latch includes a pin receiving portion pivotally accommodating the pin.

13. The latch assembly of claim 1, operably mounted on a door.

14. A method of operating a latch assembly mounted on a door, the latch assembly comprising a housing operably disposable on a plane, a latch extending from the housing, the latch pivoting generally perpendicularly to the plane between a locked position and an unlocked position and being biased toward the locked position, and a cam pivoting the latch between the locked position and the unlocked position, the method comprising:
closing the door; and
rotating the cam, thereby pivoting the latch from the unlocked position to the locked position, the latch contacting a door jamb when in the locked position, the latch being biased in the locked position.

15. The method of claim 14, in which the latch assembly further comprises an actuator shaft attached to the cam and in which the actuator shaft is rotated to rotate the cam.

16. The method of claim 15, in which the latch assembly further comprises a handle, a thumbturn, a pushbutton, or a lock and in which the handle, the thumbturn, the pushbutton, or the lock is rotated to rotate the actuator shaft.

17. The method of claim 15, in which the cam rotates about a cam axis, the cam axis being generally parallel to the plane.

18. The method of claim 17, in which the latch assembly further comprises a pin, in which the latch comprises a pin receiving portion accommodating the pin, and in which the latch pivots about the pin.

19. The method of claim 14, in which the cam comprises a point of minimum thickness and a point of maximum thickness and in which the latch contacts the point of minimum thickness when the cam is rotated to the locked position.

20. The method of claim 19, in which the latch assembly further comprises a member biasing the latch toward the locked position.

21. The method of claim 20, in which the member is disposed between the housing and the latch.

22. The method of claim 19, further comprising a spring disposed between the housing and the latch and biasing the latch toward the locked position.

23. A method of manufacturing a latch assembly, comprising:
providing a housing disposable on a generally planar surface;
rotationally disposing a cam and an actuator shaft in the housing, the cam attached to the actuator shaft;
extending a latch from the housing in a contacting relation to the cam so that the latch pivots generally perpendicularly to the planar surface between a locked position and an unlocked position; and
positioning a biasing member so as to bias the latch toward the locked position.

24. The method of claim 23, further comprising positioning a handle, a thumbturn, a pushbutton, or a lock to rotate the actuator shaft.

25. The method of claim 23, in which the positioned biasing member is a spring.

26. The method of claim 23, in which the biasing member is positioned between the housing and the latch.

27. The method of claim 23, in which the latch comprises a pin receiving portion and further comprising disposing a pin in the pin receiving portion and securing the pin to the housing.

28. The method of claim 23, in which the provided body comprises a handle.

29. The method of claim 23, in which the disposed cam comprises a point of maximum thickness and a point of minimum thickness.
